(19) United States
(12) Patent Application Publication
(10) Pub. No.: US 2021/0165224 A1
(43) Pub. Date: Jun. 3, 2021

(54) LIGHT GUIDE PLATE, METHOD FOR MANUFACTURING LIGHT GUIDE PLATE, AND IMAGE DISPLAY DEVICE USING SAME

(71) Applicant: Hitachi-LG Data Storage, Inc., Tokyo (JP)

(72) Inventor: Takeru UTSUGI, Tokyo (JP)

(21) Appl. No.: 17/049,981

(22) PCT Filed: Jul. 2, 2019
(86) PCT No.: PCT/JP2019/026349

§ 371 Date: Oct. 23, 2020

(30) Foreign Application Priority Data
Sep. 5, 2018 (JP) 2018-165878

(51) Int. Cl. G02B 27/01; G03H 1/02; G03H 1/26; F21V 8/00; G02B 27/00

(52) U.S. Cl. CPC G02B 27/0172; G03H 1/0248; G03H 1/2645; G02B 6/0038; G02B 2027/0178; G03H 2001/266; G02B 2027/0174; G02B 2027/0116; G02B 2027/0118; G02B 27/0081

(57) ABSTRACT

The purpose of the present invention is to provide a waveguide, a method for manufacturing the waveguide, and an image display device using the same, which can be applied to incident light with a wide light angle range and a wide wavelength range, and can suppress a decrease in optical efficiency while maintaining high see-through performance. In order to achieve the above purpose, the waveguide has a light diffraction unit that diffracts the incident light by a multiplex-recorded hologram, wherein the light diffraction unit has at least two regions, and the light diffraction unit diffracts light of different wavelengths by the respective regions when certain parallel light ray is incident.

### TECHNICAL FIELD

The present invention relates to a waveguide used for an image display device such as a head mounted display.

### BACKGROUND ART

In the image display device such as a head mounted display (HMD), a waveguide is used as an optical system for propagating image light emitted from a projector (image projection unit) to the eyes of a user. It is desirable that the waveguide used for the HMD be thin and have a wide field of view (FoV) through which an image can be seen. Although a half mirror can be used as the waveguide, it was difficult to reduce the thickness of the waveguide in order to secure the wide field of view.

As a background art related to this, Patent Documents 1 and 2 describe a special mirror or half mirror (called a “skew mirror” in the documents) in which a reflection axis has an inclination with respect to a surface normal by using a hologram technique. When the skew mirror is adopted for the waveguide, the same function as that of the half mirror inclined with respect to the surface of the waveguide is realized, and it is effective in reducing the thickness of the waveguide and improving the FoV.

Regarding this, in Patent Document 1, it is described that the skew mirror does not have a constraint that the reflection axis matches the surface normal, reflects light over a relatively wide wavelength range with respect to a certain reflection axis, and has a constant reflection axis over a relatively wide range of incident angles. Further, in Patent Document 2, it is described that the skew mirror has a reflection axis, that is, a skew axis that can be inclined with respect to the surface normal, and the reflected light ray by the skew mirror is emitted toward a specific “emission pupil portion”.

### CITATION LIST

### Patent Document

Patent Document 1: US 2017/0,059,759 A
Patent Document 2: WO 2017/176393 A

### SUMMARY OF THE INVENTION

### Problems to be Solved by the Invention

Since a volume hologram having a light diffraction function is thin and has characteristics such as wavelength selectivity and angle selectivity, the volume hologram can selectively diffract light, and by adopting the volume hologram for the waveguide of the HMD, it is possible to realize a thin waveguide having a wide FoV. Further, by effectively utilizing multiplex recording of the volume holograms, it is possible to display images with high image quality and high resolution having less color unevenness and brightness unevenness, and it is also possible to realize manufacturing cost reduction and stable mass productivity. However, the waveguide of the HMD using the volume hologram has a problem in optical efficiency as an image display device. This problem will be described below.

First, a relationship between the skew mirror and the waveguide described in Patent Documents 1 and 2 will be described. When light rays are incident on a surface of the waveguide including the skew mirror, a portion of the light rays is reflected by the skew mirror surface that is inclined by an angle θ_{g} from the surface of the waveguide. Here, when the light rays propagating in the waveguide at an incident angle equal to or greater than a total reflection angle θ_{TIR} (TIR: total internal reflection) is incident on the skew mirror, a portion of the light rays can be reflected by the skew mirror surface and emitted to the outside of the waveguide (emission coupler function). Further, it is also possible to make light rays incident from outside of the waveguide and propagate the light rays inside the waveguide by total reflection (incidence coupler function). As such, the skew mirror has the incidence coupler and emission coupler functions in the waveguide. The waveguide in which this skew mirror is realized by the volume hologram is called a volume hologram waveguide.

Here, a concept of the optical efficiency of the volume hologram waveguide will be described. Here, the optical efficiency of the waveguide is defined as “an input and output ratio of an integrated value of wavelength spectrum intensities of light guided through the waveguide”. That is, the optical efficiency of the waveguide is calculated using the integrated value of the wavelength spectrum intensities of all the light input (incident) on the waveguide as the denominator and the integrated value of the wavelength spectrum intensities of all the light output (emitted) from the waveguide as the numerator. Here, the integration of the wavelength spectrum intensities is performed in a range of about 400 nm to 700 nm which is a wavelength range of visible light. Further, when the light emitted from the emission coupler extends over a wide range, a light amount is integrated even in the emission coupler.

When the optical efficiency described above is applied to, for example, one half mirror, in a half mirror whose reflectance is almost constant in the wavelength range of visible light, in order to calculate the wavelength spectrum intensity to be output, the wavelength spectrum intensity to be input may be multiplied by the reflectance of the half mirror in all wavelength ranges. For that reason, the input and output ratio of the integrated value also matches the reflectance of the half mirror. Accordingly, the optical efficiency of the half mirror is reflectance itself of the half mirror.

On the other hand, in the hologram, diffraction efficiency of the hologram corresponds to the reflectance of the half mirror. However, unlike the case of the half mirror, the optical efficiency of the volume hologram waveguide does not match the diffraction efficiency of the hologram. This is because the volume hologram waveguide has “wavelength selectivity” that allows only a portion of the wavelengths of input light to be diffracted. Due to this wavelength selectivity, light to be output is limited to a portion of the wavelengths of the input light. For that reason, the optical efficiency is a product of a ratio (wavelength usage rate) of output (diffracted) wavelengths in an integration range of the wavelengths and substantial diffraction efficiency of the hologram (substantial diffraction efficiency). That is, “optical efficiency of volume hologram waveguide=substantial diffraction efficiency×wavelength usage rate”. With this, even if a hologram having the diffraction efficiency equivalent to the reflectance of the half mirror described above is used, the optical efficiency is decreased by the wavelength usage rate. Therefore, in order to improve the optical efficiency of the volume hologram waveguide, it is necessary to improve the substantial diffraction efficiency and the wavelength usage rate.

However, if the diffraction efficiency is improved, since the ratio of the light transmitted through the volume hologram to light being guided is reduced, there is a problem that light inside the waveguide is attenuated during light guide, and light intensity emitted from the emission coupler becomes uneven. In the waveguide for HMD, it is desirable that the emission coupler is wide and light is emitted substantially uniformly over the entire surface of the emission coupler. This is because, in the HMD, a region (eye-box) in which a user can visually recognize an image (virtual image) becomes wider, the user can be less likely to visually recognize an edge portion of the eye-box, which reduces stress, and also the influence of individual differences in the wearing condition and the position of the user's eyes can be reduced to obtain high sense of realism. For that reason, the diffraction efficiency needs to be suppressed to the extent that light intensities emitted from the emission coupler does not become non-uniform, and is about 15%, for example. In this case, the substantial diffraction efficiency of the entire emitted light is about 68%.

Further, in order to improve the wavelength usage rate, it is necessary to increase the number of multiplex recordings. However, when the number of multiplex recordings is increased, an angular interval of recorded holograms is narrowed, and there is a problem of image quality deterioration of a display image due to occurrence of crosstalk, noise grating, holographic scattering, and the like. For that reason, there is a limit to increase the number of multiplex recordings, and the wavelength usage rate is, for example, about 10%.

As described above, in order to improve the optical efficiency of the volume hologram waveguide, it is necessary to improve the diffraction efficiency of the hologram or the wavelength usage rate, but both the diffraction efficiency and the wavelength usage rate have limits and the optical efficiency is the product of the diffraction efficiency and the wavelength usage rate, and thus under the conditions described above, the optical efficiency is about 6.8%, and it is difficult to realize the optical efficiency higher than this. If the optical efficiency is low, an image to be displayed becomes dark and thus, for example, when an augmented reality (AR), which is one of applications of the HMD, is executed to show an image to the user by superimposing and displaying the image on the externals, the sense of realism is decreased. To compensate for this, it is necessary to increase an output light amount of the projector that emits an image, which causes problems such as an increase in power consumption, heat generation, and an increase in size of the HMD.

The present invention has been made in view of such problems, and an object thereof is to provide a waveguide having high optical efficiency by overcoming the problems described above, a method for manufacturing the waveguide, and an image display device using the waveguide.

### Solutions to Problems

In view of the background art and problems described above, the present invention provides, as an example, a waveguide that has a light diffraction unit that diffracts incident light by a multiplex-recorded hologram, in which the light diffraction unit has at least two regions, and the light diffraction unit diffracts light of different wavelengths by the respective regions when certain parallel light ray is incident.

### Effects of the Invention

According to the present invention, a waveguide which improves optical efficiency, a method for manufacturing the waveguide, and an image display device using the waveguide can be provided.

### BRIEF DESCRIPTION OF THE DRAWINGS

FIG. 1A is an appearance diagram of an image display device in Embodiment 1.

FIG. 1B is an appearance diagram illustrating a usage example of the image display device in Embodiment 1.

FIG. 2 is a diagram illustrating a block configuration of the image display device in Embodiment 1.

FIG. 3 is a schematic diagram illustrating an overall configuration of a waveguide in Embodiment 1.

FIG. 4 is a cross-sectional view in a light guide surface of the waveguide in Embodiment 1.

FIG. 5A is a schematic view of a method for manufacturing a volume hologram in Embodiment 1.

FIG. 5B is a view illustrating an optical arrangement when reproducing the volume hologram in Embodiment 1.

FIG. 6A is a view illustrating a concept of optical efficiency of a volume hologram waveguide in Embodiment 1.

FIG. 6B is a table showing a relationship between the number of multiplex recordings M of a volume hologram and a recording angle θ_{w}, a reproduction wavelength λₚ, and a reproduction incident angle θᵢₙ in Embodiment 1.

FIG. 7A is a graph showing wavelength selectivity of reproduction light in Embodiment 1.

FIG. 7B is a graph showing wavelength selectivity of multiplex-recorded holograms when reproduction incident light is fixed at a certain angle in Embodiment 1.

FIG. 8A is a graph showing angle selectivity of the reproduction light in Embodiment 1.

FIG. 8B is a graph showing angle selectivity of multiplex-recorded holograms when the reproduction incident light is fixed to a certain wavelength in Embodiment 1.

FIG. 9 is a graph for describing a problem in a case where the hologram is recorded with a multiplex recording interval made narrower in order to increase the wavelength usage rate in Embodiment 1.

FIG. 10 is a schematic diagram illustrating a configuration in which a hologram recording region of the waveguide in Embodiment 1 is spatially divided into regions, and multiplex recording is performed so that a set of wavelengths reproduced in each region is different.

FIG. 11 is a specific design example of the waveguide in Embodiment 1.

FIG. 12 is a schematic diagram illustrating a configuration of a waveguide in Embodiment 2.

### MODE FOR CARRYING OUT THE INVENTION

Embodiments of the present invention will be described below with reference to the drawings. In the following embodiments, a case where an image display device is a glasses-type head mounted display (HMD) will be described.

### Embodiment 1

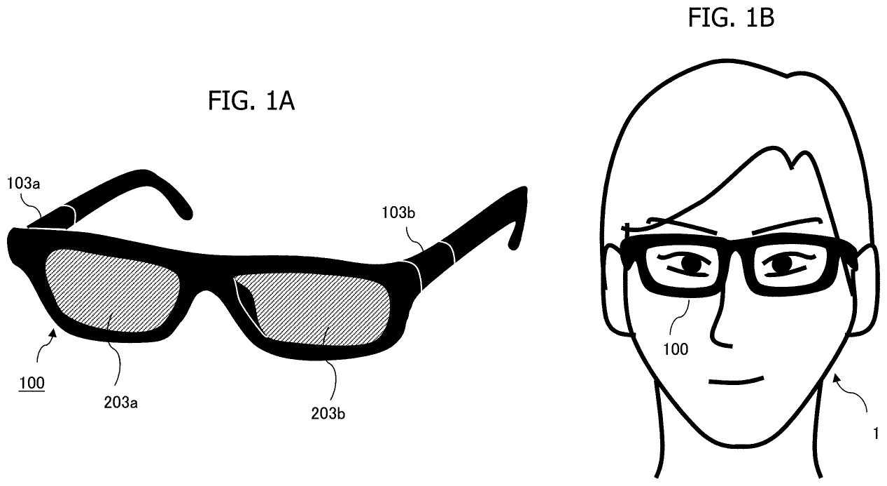

FIG. 1A is an appearance diagram of an image display device according to this embodiment. Further, FIG. 1B is an appearance diagram illustrating a usage example of the image display device.

In FIG. 1A, a glasses-type image display device (HMD) 100 includes an image projection unit 103a that projects an image to be displayed on the right eye of a user 1 and an image projection unit 103b that projects an image to be displayed on the left eye of the user 1, in the portions corresponding to temples of the glasses. Further, emission couplers 203a and 203b for delivering the images projected by the image projection units 103a and 103b to the eyes of the user 1 are provided on the portions corresponding to the lenses of the glasses. The emission couplers 203a and 203b can not only display an image but also transmit light from the outside world, and can display augmented reality (AR) to be shown to the user by superimposing the image on the outside world. As illustrated in FIG. 1B, the user 1 can wear the image display device 100 on his or her head to see an image with both eyes.

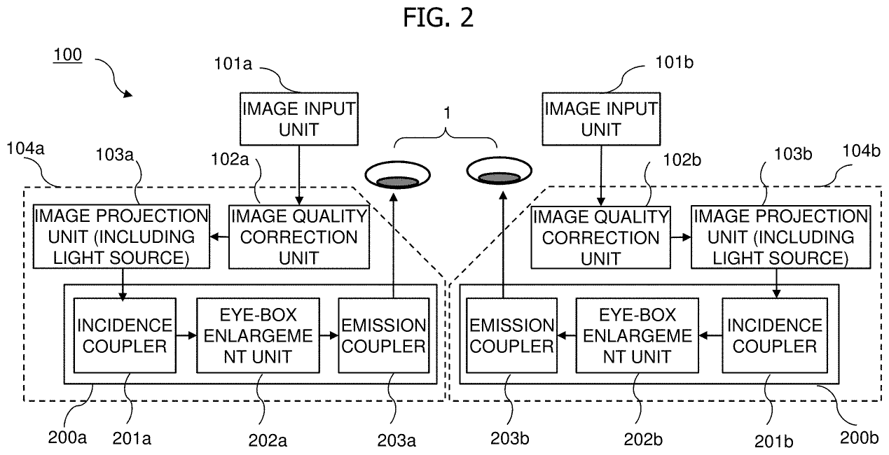

FIG. 2 is a diagram illustrating a block configuration of the image display device 100. The image display device 100 is configured with a right-eye image display unit 104a that displays an image on the right eye of the user and a left-eye image display unit 104b that displays an image on the left eye of the user. In FIG. 2, reference symbols a and b are given to respective constituent blocks for the right eye and the left eye, but since the two image display units have the same configuration, the reference numerals for the right eye a and the left eye b will be omitted, and description will be made without particularly distinguishing the right and left eyes.

In FIG. 2, the image display unit 104 first generates an image to be displayed by an image quality correction unit 102 and an image projection unit 103 based on image data sent from an image input unit 101. The image quality correction unit 102 corrects color and brightness of the image to be displayed. Here, adjustment is performed so that color unevenness, brightness unevenness, color deviation, and the like are uniformized and minimized. The image projection unit 103 is configured using a small projector including a light source, and serves as an optical system that projects a virtual image of an image. That is, when the image projection unit 103 is directly looked into, a two-dimensional image can be seen at a position at a certain distance. Here, the distance at which the image (virtual image) is projected may be a certain finite distance or may be infinite.

The image generated by the image projection unit 103 is emitted as a light ray group that projects a virtual image at a certain distance. This light ray group has wavelengths corresponding to at least three colors of red (R), green (G), and blue (B), and the user can see a color image. Further, this light ray group has a spread of approximately 60 degrees in the horizontal direction and approximately 30 degrees in the vertical direction, and an image with a wide field of view (FoV) of the projected virtual image can be seen.

The light ray group emitted from the image projection unit 103 is incident on a waveguide 200 via an incidence coupler 201. The incidence coupler 201 converts the direction of the light ray group incident on the waveguide into a direction in which the light ray can propagate in the waveguide 200 by total reflection. In this case, by converting the direction while maintaining a relative relationship of directions of respective light rays of the light ray group, it is possible to display a high-definition image without image distortion or blur.

The light ray group that is made incident on the waveguide 200 is propagated by repeating total reflection, and then is incident on an eye-box enlargement unit 202. The eye-box enlargement unit 202 has a function of enlarging an eye-box (a region in which a virtual image can be visually recognized) in which a user can see an image. If the eye-box is wide, stress is reduced because it is difficult for the user to see the edge of the eye-box, and also the influence of individual differences in the wearing condition and the user's eye position is reduced, thereby capable of obtaining a high sense of realism.

In the eye-box enlargement unit 202, the incident light ray group is duplicated while maintaining the relative relationship in the light ray direction and is emitted to an emission coupler 203. That is, the light ray group emitted from the image projection unit 103 is spatially expanded while maintaining the relative relationship in the light ray direction (angle).

The emission coupler 203 emits the incident light ray group to the outside of the waveguide 200 and delivers the light ray group to the eyes of the user 1. That is, the emission coupler 203, contrary to the incidence coupler 201, converts the direction of the incident light ray group into a direction in which the light ray can be emitted to the outside of the waveguide 200.

Further, the emission coupler 203 also has a function of enlarging the eye-box in a direction different from the direction in which the eye-box enlargement unit 202 expands. That is, the light ray group incident on the emission coupler 203 is duplicated while maintaining the relative relationship in the light ray direction, spatially expanded, and emitted to the outside of the waveguide 200.

The configuration described above is substantially common to the right-eye image display unit 104a and the left-eye image display unit 104b. With the configuration described above, the user 1 can see the images (virtual images) displayed on these two image display units 104a and 104b.

In the image display device 100 of FIG. 1A described above, only the part of the emission coupler 203, which is a part of the waveguide 200, can be seen, but the other parts of the waveguide 200 are hidden by a black frame part so that the other parts cannot be seen from the outside. This is because when light (external light) of the externals is incident on the waveguide 200 from an unintended angle, the incident light may become stray light and deteriorate image quality of a displayed image. Therefore, parts other than the emission coupler 203 are made as invisible as possible from the externals so that external light is not incident on the waveguide 200.

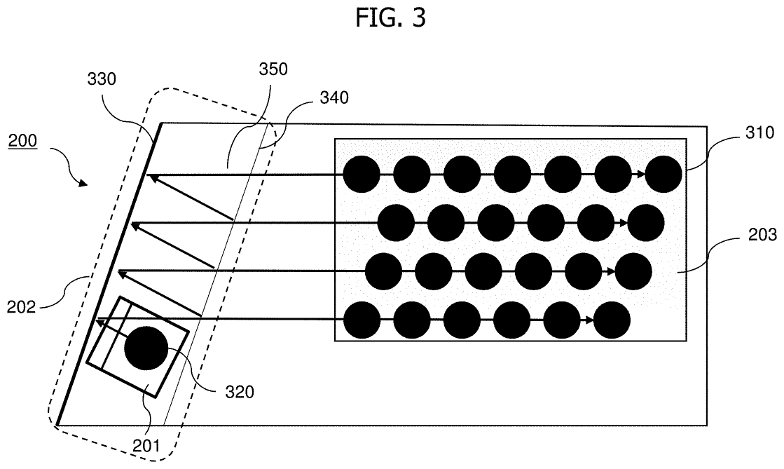

FIG. 3 is a schematic diagram illustrating the overall configuration of the waveguide 200. The waveguide 200 is configured to include the incidence coupler 201, the eye-box enlargement unit 202, and the emission coupler 203, which are accommodated in a synthetic resin substrate such as glass or plastic and have a thickness of about 1 to 2 mm. As described above, the light ray group emitted from the image projection unit 103 has a wide wavelength range corresponding to RGB light and a wide angle range corresponding to FoV of 60 degrees in the horizontal direction and 30 degrees in the vertical direction, and the light ray group is incident on the incidence coupler 201. In FIG. 3, a path in the waveguide 200 for a central light ray 350 in the light ray group is illustrated. The central light ray 350 corresponds to a pixel at the substantially center of the displayed image, and is actually luminous flux having a finite thickness of several mm diameter.

The incidence coupler 201 is composed of a prism and converts the direction of an incident light ray group 320 into a direction in which the waveguide 200 is guided by total reflection. The light ray group emitted from the incidence coupler 201 propagates to the eye-box enlargement unit 202 by internal reflection inside the waveguide 200.

The eye-box enlargement unit 202 reflects the light ray group propagating through the waveguide 200 by a mirror surface 330 and a beam splitter surface 340 and propagates the light ray group to the emission coupler 203. In this case, beam splitter surface 340 duplicates the light ray group while maintaining the relative relationship in the light ray direction, so that the eye-box in which the user sees the image is enlarged vertically. Here, the eye-box enlargement unit 202 has a structure sandwiched between the mirror surface 330 and the beam splitter surface 340, the mirror surface 330 is composed of a mirror having a reflectance of about 100%, and the beam splitter surface 340 is composed of a partial transmission mirror having a reflectance of about 70%. The mirror surface 330 and the beam splitter surface 340 are created by a dielectric multilayer film or metal vapor deposition, and are designed so as to be applicable to the light ray group 220 having a wavelength range corresponding to RGB light and an angle range corresponding to FoV at 60 degrees with horizontal×30 degrees with vertical.

The emission coupler 203 is composed of a volume hologram that is a light diffraction unit, converts the direction of the incident light ray group, and emits the light ray group to the outside of the waveguide 200. Since the volume hologram diffracts a part of light being guided, the rest of the light is guided as it is. By repeating this, a large number of emitting light ray groups 310 are duplicated in a plane and are emitted from the emission coupler 203, and are delivered to the eyes of the user 1. With this, the eye-box is enlarged laterally.

Here, the reflectance of the beam splitter surface 340 and the diffraction efficiency of the volume hologram configuring the emission coupler 203 need to be designed so that an amount of light (amount of light in the eye-box) emitted by the emission coupler 203 is substantially uniform. Therefore, reflectance distributions of the mirror surface 330 and the beam splitter surface 340 may be uniform or non-uniform. Further, by providing a gradation that is an uneven distribution in the vertical direction of the figure, the diffraction efficiency of the volume hologram configuring the emission coupler 203 can also be designed so that the amount of light in the eye-box is substantially uniform.

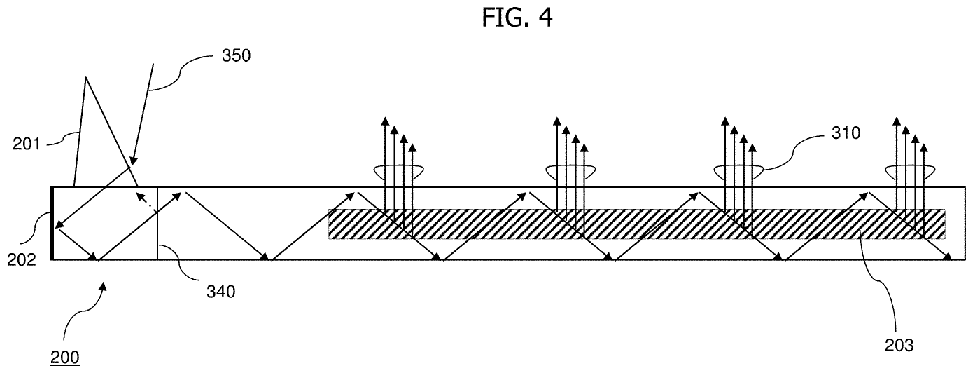

FIG. 4 is a cross-sectional view of the inside of the light guide surface when the waveguide of FIG. 3 is seen from below. As illustrated in FIG. 4, a light ray group emitted from the image projection unit 103 propagates to the eye-box enlargement unit 202 by the incidence coupler 201, further propagates to the emission coupler 203, and a large number of light ray groups 310 emitted are duplicated in the plane from the emission coupler 203 and delivered to the eyes of the user 1. The incidence coupler 201 is composed of a prism, and the volume hologram configuring the emission coupler 203 is composed of a reflection hologram. Hereinafter, a method for manufacturing this volume hologram will be described.

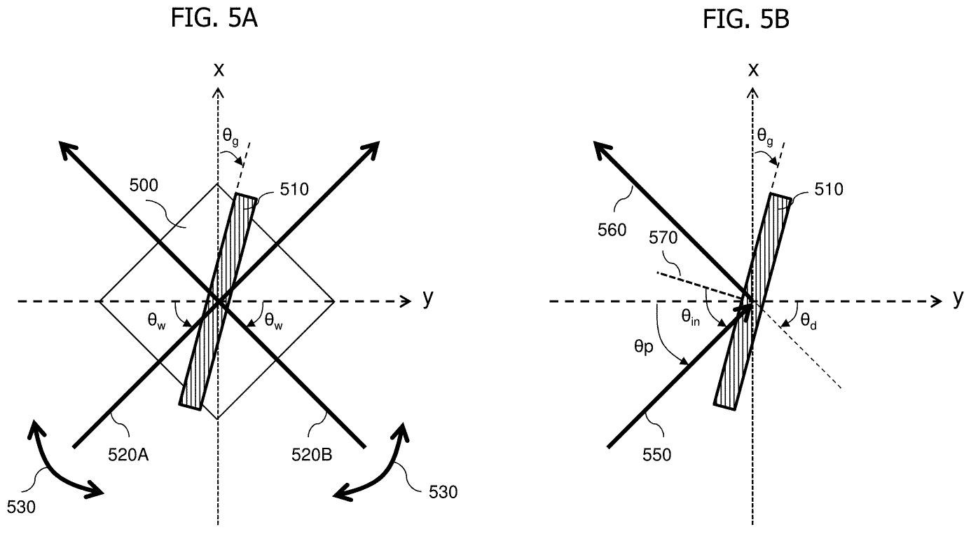

FIG. 5A illustrates a schematic view of a method for manufacturing a volume hologram. The volume hologram can be manufactured by recording interference fringes, which are created by recording light beams 520A and 520B emitted from a light source with high coherence such as laser light on a recording medium 510 such as a photopolymer which is a photosensitive material, as a hologram. Here, as illustrated in FIG. 5, the x-axis and the y-axis are defined, and the z-axis is defined in the direction perpendicular to the paper surface. The recording light beams 520A and 520B are both parallel light which is inclined from the y-axis by θ_{w} (recording angle) in line symmetry with respect to the x-axis, and are plane wave recording beams. With this, an interference fringe plane is formed parallel to the xz-plane. Further, the recording medium 510 is inclined by θ_{g} from the x-axis. Since the interference fringe plane becomes a reflection surface (skew mirror surface) of the waveguide, θ_{g} is the inclination of the reflection surface from a recording medium surface. Further, a prism 500 is used in order to avoid the decrease in light utilization efficiency during recording due to surface reflection of the recording medium and the influence of refraction on the recording medium 510.

As illustrated by an arrow 530, the recording light beams 520A and 520B are rotated about the z-axis as the center of rotation to change an angle between the recording light beams to perform multiplex recording. Here, by making the recording light beams line-symmetric with respect to the x-axis at all times, the interference fringe plane can be made parallel to the xz-plane at all times. With this, the interference fringe plane (reflection surface) can be fixed while being inclined by θ_{g} from the recording medium surface, and holograms with different interference fringe pitches (grating intervals) can be multiplex-recorded.

Incidentally, the waveguide can be manufactured by using the volume hologram as a light diffraction unit and sandwiching both sides of the light diffraction unit with substrates.

FIG. 5B illustrates an optical arrangement in the case of reproducing a volume hologram (skew mirror) subjected to multiplex recording by the method described above. Here, “reproduction” means irradiating a hologram with incident light to diffract the light, and will be used in this meaning in the future.

When a reproduction light ray 550 inclined by θₚ (reproduction angle) from the y-axis direction is incident on the volume hologram (an incident angle to the medium is θᵢₙ=θₚ+θ_{g}, which is called a reproduction incident angle), a diffracted light 560 is emitted at an angle inclined by θ_{d} from the y-axis when Bragg selectivity is satisfied. In a case where the reproduction light ray has a wide wavelength range corresponding to RGB light and a wide angle range corresponding to FoV of 60 degrees in the horizontal direction and 30 degrees in the vertical direction (in air), if the volume hologram can diffract light, the volume hologram can be used as an emission coupler of the waveguide. Further, since the wavelength of the light ray is integrated and recognized by the eyes of an observer by a color matching function, wavelength distribution of the emitted light rays from the volume hologram does not need to be the same as the wavelength distribution of the incident light rays, and it is sufficient that at least the wavelengths corresponding to the three colors of RGB are included in a well-balanced manner. Further, in this figure, power density of the emitted light ray with respect to power density of the incident light ray is called the diffraction efficiency. Here, the above θ_{g}, θ_{w}, θₚ, θ_{d}, and θᵢₙ are all described as angles within the recording medium 510.

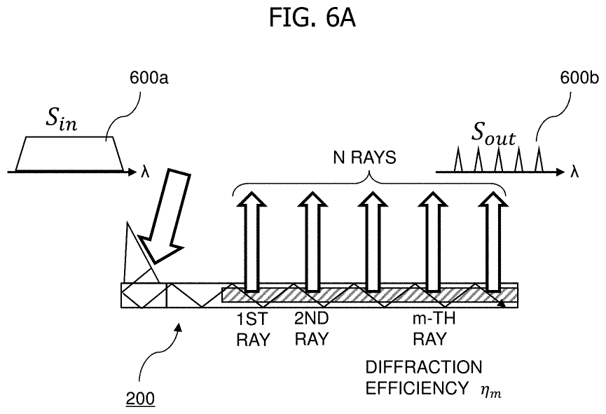

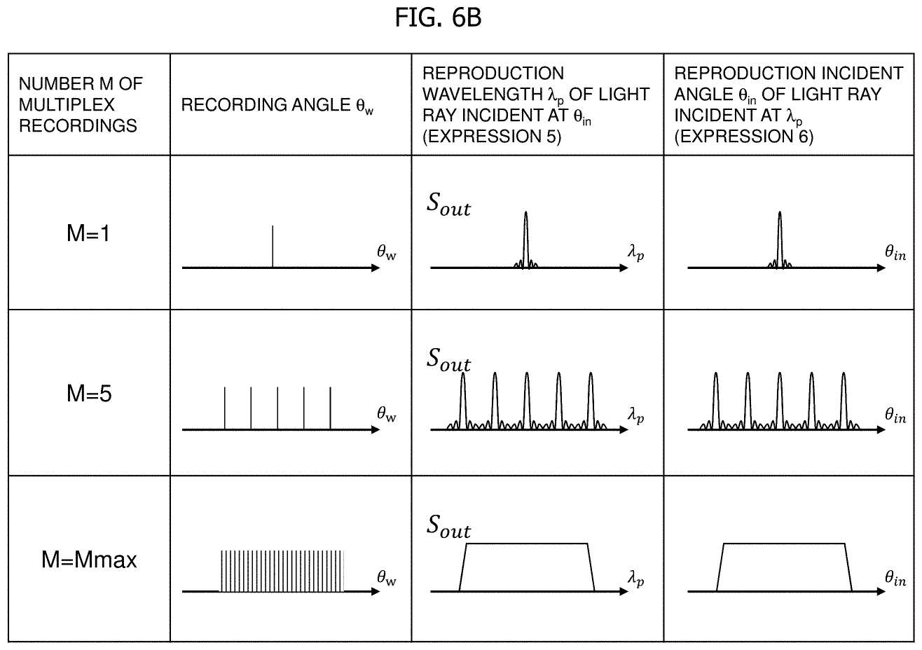

FIG. 6A illustrates a concept of optical efficiency of the volume hologram waveguide. First, optical efficiency H of the waveguide is defined by the following expression (1).

$$[ Expression 1 ]$$

$$H = \frac{\int {S}_{out} ( λ ) d λ}{\int {S}_{in} ( λ ) d λ} \qquad ( 1 )$$

Here, Sᵢₙ(λ) and Sₒᵤₜ(λ) are wavelength spectrum distributions of incident light and emitted light, and are illustrated by graphs 600a and 600b in FIG. 6A in which the horizontal axis represents wavelength and the vertical axis represents spectrum intensity. Further, it is assumed that the integration is performed in the wavelength range of visible light. That is, the optical efficiency H is calculated by a ratio of the total sum (integrated value) of energy of the incident light and energy of the emitted light. The optical efficiencies dealt with here are all for a light ray having a single angle. However, the same idea can be used when considering light rays at all angles to be guided.

A plurality of emitted light is generated in the volume hologram waveguide. Therefore, it is assumed here that N light rays are emitted. Further, the vertical duplication by the eye-box enlargement unit 202 is omitted for simplification of description, but can be expanded by the same idea.

In this case, optical efficiency H_{A11} of the volume hologram waveguide can be expressed by the following expression (2).

$$[ Expression 2 ]$$

$${H}_{All} = {\sum }_{m = 1}^{N} {h}_{m} \qquad ( 2 )$$

Here, hₘ is the optical efficiency of the m-th emitted light ray and can be expressed by the following expression (3).

$$[ Expression 3 ]$$

$${h}_{m} = \frac{M}{{M}_{max}} \times {η}_{m} {\prod }_{i = 1}^{m - 1} ( 1 - {η}_{i} ) \qquad ( 3 )$$

Here, M is the number of multiplex recordings, and Mₘₐₓ is the maximum number of multiplex recordings described later. ηₘ is the diffraction efficiency of the m-th emitted light ray. Accordingly, the optical efficiency H_{A11} of the volume hologram waveguide is given by the following expression (4).

$$[ Expression 4 ]$$

$${H}_{All} = \frac{M}{{M}_{max}} \times {\sum }_{m = 1}^{N} {η}_{m} {\prod }_{i = 1}^{m - 1} ( 1 - {η}_{i} ) = {H}_{M} \times {H}_{η} \qquad ( 4 )$$

In order to improve the optical efficiency H_{A11} of the volume hologram waveguide, it is sufficient to improve either or both of H_{M}=M/Mₘₐₓ and H_{η}=ΣηₘΠ(1−ηᵢ). Here, H_{M}=M/Mₘₐₓ is called “wavelength usage rate”, and H_{η}=ΣηₘΠ(1−ηᵢ) is called “substantial diffraction efficiency”. Hereinafter, these two items will be described.

The substantial diffraction efficiency H_{η} represents the efficiency with which incident light is emitted at a certain wavelength. The optical efficiency can be improved by improving the substantial diffraction efficiency, but this substantial diffraction efficiency has a trade-off relationship with uniformity of the intensity of emitted light ray.

For example, if N=7 and the diffraction efficiency of the hologram is set to 100% (ηᵢ=1), the substantial diffraction efficiency will be 100%, but ηᵢ=100%, η₂=0%, η₃=0% . . . , and it becomes difficult to duplicate the emitted light ray in the light guide direction. Further, if the diffraction efficiency of the hologram is set to 30%, although the substantial diffraction efficiency is decreased to 92%, ηᵢ=30%, η₂=21%, η₃=15% . . . , which is non-uniform, it is possible to duplicate the emitted light ray in the light guide direction. Further, if the diffraction efficiency of the hologram is set to 2%, although the substantial diffraction efficiency is decreased to 13%, the uniformity can be kept high. As such, there is a trade-off relationship between the substantial diffraction efficiency and the uniformity of the intensity of emitted light ray.

In order to solve the relationship described above, a method of making the diffraction efficiency of the hologram non-uniform in the light guide direction can be considered. However, if this is done, there is a problem that external light transmittance is also non-uniform.

Therefore, it is difficult to increase the substantial diffraction efficiency while maintaining the uniformity of the intensity of emitted light ray, and practically, for example, when N=7, the limit is about 15%. In this case, the substantial diffraction efficiency is about 68% (H_{η}=68%).

The wavelength usage rate H_{M} represents a ratio of the wavelengths utilized (reproduced) by the volume hologram. This is due to wavelength selectivity of the volume hologram. For example, since a half mirror to which an appropriate coating is applied has almost no wavelength selectivity, the wavelength usage rate is almost 100%. In the volume hologram, the optical efficiency can be improved by improving the wavelength usage rate, but for that purpose, it is necessary to increase the number of multiplex recordings.

The wavelength usage rate H_{M} is determined by H_{M}=M/Mₘₐₓ. Here, M is the number of multiplex recordings of the hologram, and Mₘₐₓ is the maximum number of multiplex recordings. The maximum number of multiplex recordings Mₘₐₓ is defined as the number of multiplex recordings when the wavelength selectivity is lost, that is, when all the incident wavelengths are diffracted, when the multiplex recording is performed by narrowing the recording angle θ_{w} during multiplex recording.

FIG. 6B shows the relationship between the number of multiplex recordings M of the volume hologram, the recording angle θ_{w}, the reproduction wavelength λₚ in air, and the reproduction incident angle θᵢₙ. Consider a case where holograms are multiplex-recorded by the optical arrangement of FIG. 5A, and holograms are reproduced by the optical arrangement of FIG. 5B. When a recording wavelength λ_{w} and the reproduction wavelength λₚ in air are set, a condition of the reproduction wavelength λₚ at which the reproduction incident light is diffracted by Bragg match (diffracted light is generated) is given by the following expression (5) for a hologram recorded at a certain recording angle θ_{w}.

$$[ Expression 5 ]$$

$${λ}_{p} = \frac{cos ( {θ}_{in} - {θ}_{g} )}{cos {θ}_{w}} {λ}_{w} \qquad ( 5 )$$

Here, θ_{g} is an inclination angle of the interference fringe plane from the surface of the recording medium, and is a constant determined at the time of recording. Further, θᵢₙ is an incident angle with respect to the surface of the recording medium during reproduction, θ_{w} is an angle from the y-axis in FIG. 5B during multiplex recording, and has a value corresponding to the number of multiplex recordings. Further, when these variables are rewritten as the condition of the incident angle θᵢₙ with respect to the surface of the recording medium, the following expression (6) is obtained.

$$[ Expression 6 ]$$

$${θ}_{in} = {cos}^{- 1} ( \frac{{λ}_{p}}{{λ}_{w}} cos {θ}_{w} ) + {θ}_{g} \qquad ( 6 )$$

When the recording wavelength λ_{w} and the reproduction wavelength λₚ are determined, the reproduction incident angle θᵢₙ is determined by the recording angle θ_{W} during recording. Further, in this case, the diffraction direction θ_{d} of the reproduction light is given by the following expression (7).

$$[ Expression 7 ]$$

$${θ}_{d} = {tan}^{- 1} ( \frac{{λ}_{w} sin {θ}_{in} - 2 {λ}_{p} sin {θ}_{g} cos {θ}_{w}}{{λ}_{w} cos {θ}_{in} - 2 {λ}_{p} cos {θ}_{g} cos {θ}_{w}} ) \qquad ( 7 )$$

From the relational expressions described above, the incident angle (θᵢₙ) during reproduction and the angle (θ_{d}) of the emitted light can be calculated from the recording conditions (θ_{w}, λ_{w}).

FIG. 6B shows the relationships described above. As the number of multiplex recordings M increases, the conditions to be reproduced also increase accordingly. The number of multiplex recordings which has no wavelength selectivity and diffracts all wavelengths in the visible light range is Mₘₐₓ.

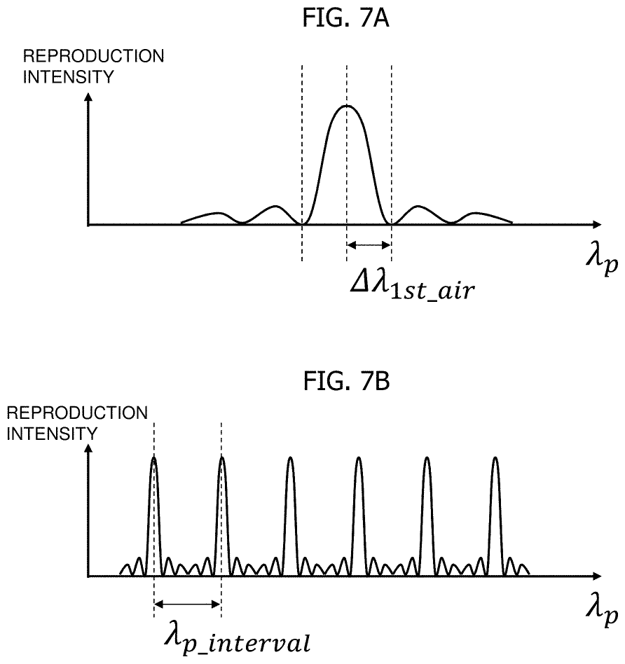

FIG. 7 shows Bragg wavelength selectivity. FIG. 7A shows wavelength selectivity of reproduction light. When the reproduction incident light is fixed at a certain angle, a wavelength reproducible by one plane wave hologram is in the form of a Sinc function as shown in the figure, and a reproducible wavelength width (in air) is approximately the half-value width of wavelength selectivity, and therefore is expressed by the following expression (8).

$$[ Expression 8 ]$$

$${Δλ}_{1 st \_ air}^{n} = \frac{{( 2 {λ}_{p} cos {θ}_{g} cos {θ}_{w}^{n} - {λ}_{w} cos {θ}_{in} )}^{2}}{2 {n}_{media} {L}_{z} {cos}^{2} {θ}_{w}^{2} cos ( 2 {θ}_{g} - {θ}_{in} )} \qquad ( 8 )$$

Here, n (n=1, 2, is a subscript of the multiplex recording number. Further, n_{media} and L_{z} are the refractive index and the thickness of the recording medium 510, respectively. It is assumed that the recording wavelength λ_{w}, the reproduction wavelength λₚ, the angle θ_{g}, the refractive index n_{media}, and the thickness L_{z} do not change during recording. FIG. 7B shows wavelength selectivity of the multiplex-recorded hologram when the reproduction incident light is fixed at a certain angle. A wavelength interval λ_{p_interval} that is reproduced by the expression (5) can be calculated from the angle θ_{w} for performing the multiplex recording, and the following expression (9) is obtained.

$$[ Expression 9 ]$$

$${λ}_{p \_ interval}^{n} = \vert cos ( {θ}_{in} - {θ}_{g} ) ( \frac{1}{cos {θ}_{w}^{n + 1}} - \frac{1}{cos {θ}_{w}^{n}} ) \vert {λ}_{w} \qquad ( 9 )$$

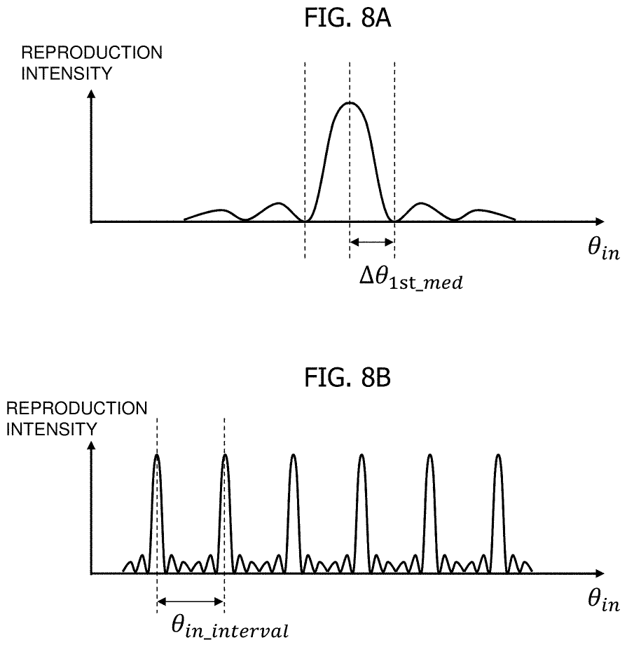

Further, FIG. 8 shows Bragg angle selectivity. FIG. 8A shows angle selectivity of the reproduction light. When the reproduction incident light is fixed to a certain wavelength, an angle reproducible by one plane wave hologram is in the form of a Sinc function as shown in the figure, and a reproducible angular width (in the recording medium) can be expressed by the following expression (10).

$$[ Expression 10 ]$$

$${Δθ}_{1 st \_ med}^{n} = \frac{{( 2 {λ}_{p} cos {θ}_{g} cos {θ}_{w}^{n} - {λ}_{w} cos {θ}_{in} )}^{2}}{2 {n}_{media} {L}_{z} cos {θ}_{w}^{n} ( {λ}_{w} sin {θ}_{g} - {λ}_{p} cos {θ}_{w}^{n} sin ( 2 {θ}_{g} - {θ}_{in} ) )} \qquad ( 10 )$$

FIG. 8B shows angle selectivity of the multiplex-recorded hologram when the reproduction incident light is fixed to a the expression (6) can be calculated from the angle θ_{W} for performing the multiplex recording, and the following expression (11) is obtained.

$$[ Expression 11 ]$$

$${θ}_{in \_ interval}^{n} = \vert {cos}^{- 1} ( \frac{{λ}_{p}}{{λ}_{w}} cos {θ}_{w}^{n + 1} ) - {cos}^{- 1} ( \frac{{λ}_{p}}{{λ}_{w}} cos {θ}_{w}^{n} ) \vert \qquad ( 11 )$$

As the interval of recording angle θ_{W} decreases, the θ_{in_interval} decreases accordingly.

By using the relational expressions as described above, it is possible to calculate the wavelength usage rate when recording is performed under a certain condition.

The wavelength usage rate is calculated by the following expression (12) using the maximum number of multiplex recordings Mₘₐₓ.

$$[ Expression 12 ]$$

$${H}_{M} = \frac{M}{{M}_{max}} = 〈 \frac{{Δθ}_{1 st \_ med}}{{θ}_{in \_ interval}} 〉 = 〈 \frac{{Δλ}_{1 st \_ air}}{{λ}_{p \_ interval}} 〉 \qquad ( 12 )$$

Here, < > means an average value in all multiplex recordings (number n). Therefore, Mₘₐₓ corresponds to the number of multiplex recordings when recording is performed so that there is no gap in wavelength selectivity. Further, Mₘₐₓ also matches the number of multiplex recordings when recording is performed so that there is no gap in angle selectivity.

From the expression (12), it can be seen that the wavelength usage rate H_{M} can be improved by filling the gap of wavelength selectivity, by performing recording with the gap of the multiplex recording angle θ_{W} of the hologram narrowed, that is, by making θ_{in_interval} small. That is, this is the same as increasing the number of multiplex recordings M. However, if the number of multiplex recordings M is increased, there are the following problems, for example.

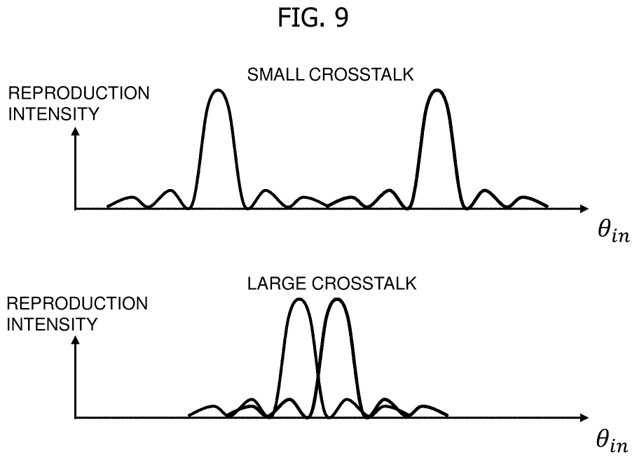

FIG. 9 is a diagram for describing a problem in a case where the hologram is recorded with the multiplex recording interval narrowed in order to increase the wavelength usage rate. The upper diagram of FIG. 9 is a schematic diagram when recording is performed with a sufficient multiplex recording interval left. In contrast, the lower diagram of FIG. 9 is a schematic diagram when recording is performed with the recording angle interval narrowed, and when the recording angle interval is narrowed as described above, crosstalk between adjacent holograms occurs. This is a phenomenon in which side lobes of the Sinc function interfere with each other and reproduction intensity is strengthened or weakened depending on the phase difference between the side lobes, which causes deterioration in image quality. Since it is usually difficult to control the phase difference between adjacent holograms of multiplex-recorded hologram, this problem is an essential problem, and it becomes difficult to maintain uniform diffraction efficiency. Therefore, it is necessary to leave a sufficient space between adjacent holograms. For example, when θ_{in_interval}=rΔθ_{1st_med} (r is a positive real value), it is necessary to set r=about 7 to 10 or more. Furthermore, if a lot of multiplex recordings are performed with a recording angle interval narrowed, reproduction of the holograms recorded in the first half of a recording process and reproduction of the holograms written by scattered light in the medium will affect the second half of the recording process, and there are problems such as generation of noise grating and holographic scattering where unintended holograms are written, which causes deterioration in image quality in the HMD. Accordingly, r needs to be sufficiently large. For example, when r=10, the wavelength usage rate H_{M} becomes 10% (from H_{M}=1/r). This is the limit of wavelength usage rate (H_{M}=10%).

From the description as above, the optical efficiency of the waveguide is limited to about H_{A11}=H_{η}×H_{M}=68%×10%=6.8%. Hereinafter, a method for improving the optical efficiency by overcoming this constraint will be described.

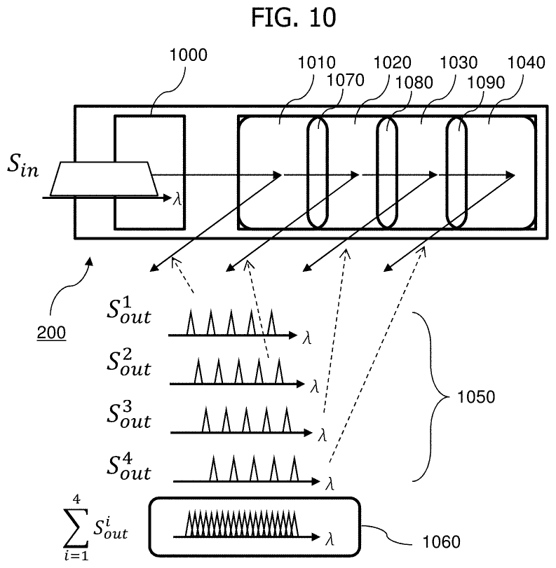

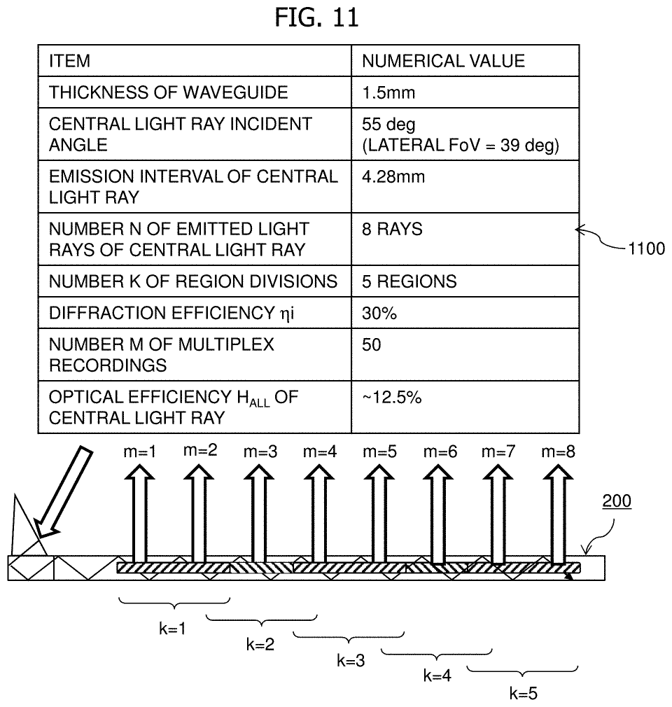

FIG. 10 is a diagram for describing a region division recording method in this embodiment for solving the problems described above. In this method, a hologram recording region of the recording medium is spatially divided into regions. Then, multiplex recording is performed so that a set of reproduced wavelengths is different in each region. That is, a set of recording angles θ_{w} is changed for each region. With this, in each region, the wavelength usage rate as a whole can be improved even if the number of multiplex recordings is small. Further, if the diffraction efficiency of one region is too high, an amount of diffracted light at the rear decreases, but in this method, since different wavelengths are reproduced in different parts of the region, even if the hologram in the front has high diffraction efficiency, the hologram in the rear can have high diffraction efficiency at another wavelength. Therefore, the diffraction efficiency of each region may be increased, and the upper limit of the diffraction efficiency can be improved. Incidentally, in FIG. 10, the pupils are one-dimensional duplication system, but can also be used in a two-dimensional duplication system.

In FIG. 10, a light ray from a light source having incident wavelength spectrum intensity Sᵢₙ is incident from an incidence coupler 1000. This incident light ray is incident on the waveguide 200 by the incidence coupler 1000, and is guided inside the waveguide by total reflection. Then, when the light ray is incident on the first emission coupler region 1010, a part of light is emitted to the outside of the waveguide 200. Here, when looking at wavelength spectrum intensity Sₒᵤₜ¹ of the emitted light ray having a certain angle, there is a missing tooth state due to Bragg wavelength selectivity, and peaks of the number M of multiple recordings or less stand. Further, when the light transmitted through the emission coupler region 1010 is incident on an emission coupler region 1020, a part of the light is emitted to the outside of the waveguide 200. In this case, when looking at wavelength spectrum intensity S²out of the emitted light ray having the angle described above, as compared with the wavelength spectrum intensity S²out of the light ray parallel to the light ray emitted from the emission coupler region 1010, all the peak positions are deviated by Δλ_{1st_med}, which is the half-value width of the wavelength selectivity, or more. With this, light having a wavelength other than the wavelength emitted in the region 1010 is emitted from the region 1020. Similarly, in regions 1030 and 1040, by deviating the set of emitted (diffracted) wavelengths, wavelengths different from the wavelengths diffracted in the front regions are diffracted. Incidentally, the sets of wavelengths diffracted in the respective regions may or may not be evenly spaced, and need not be plural.

Here, although the peak positions of emission spectrum intensity differ depending on the angle of the light ray, the number of peaks and the wavelength usage rate, which is a ratio of missing teeth, do not change substantially, and the relationship described above can be established for light rays of all angles. Further, boundaries of respective divided regions may be formed with overlapping portions 1070, 1080, and 1090 to reduce the influence of the region boundary. Further, the numbers of multiplex recordings (number of peaks of reproduction wavelength spectrum intensity) in the respective divided regions do not necessarily have to match. Furthermore, by changing offset amounts (overall shift amount) of the recording angles in the respective divided regions, reproduction may be performed only in the minimum necessary angle range by the respective divided regions, and the dynamic range of the recording medium (for example, index called M# and the like) may be effectively utilized.

Next, the optical efficiency when the region division recording is performed will be described. In principle, if the region division is performed so that the sum 1060 of all diffracted wavelength spectrum intensities in each region illustrated in FIG. 10 has no gap, it is also possible to bring the wavelength usage rate H_{M} close to 100%. In this case, the number of regions is approximately the reciprocal of the wavelength usage rate H_{M}. Further, since the diffraction efficiency of each region can also be increased by increasing the number of regions, it is also possible in principle to bring the substantial diffraction efficiency H₁ close to 100%. Accordingly, there is a possibility that the optical efficiency H_{A11} for a light ray having a certain angle can be dramatically improved as compared with the conventional case.

FIG. 11 illustrates a specific design example. The waveguide has a thickness of 1.5 mm and has a recording medium layer of 0.5 mm. The incident angle of the central light ray in the waveguide is 55 degrees, and in this case, the lateral FoV is about 39 degrees. Further, in this case, Mₘₐₓ becomes about 1000. The size of the emission coupler is set so that the number N of emitted light rays of the central light ray is 8 (m=1 to 8), and the number K of region divisions is set to 5 (k=1 to 5). Further, the diffraction efficiency in each region is set to approximately ηᵢ=30%, and 50 multiplex recording is performed (M=50). In this case, since the substantial diffraction efficiency H_{η} of the central light ray is about 50% and the wavelength usage rate H_{M} is multiplied by K by the region division recording, H_{M}=K×M/Mₘₐₓ=5×50/1000=about 25%, and thus the optical efficiency H_{A11} is about 12.5%. This has realized an efficiency improvement of about twice as much as the conventional limit of 6.8%. Further, the region division number K, the number of multiplex recordings M, and the diffraction efficiency ηᵢ can be set to larger values, and further improvement in optical efficiency can be expected.

A feature of this method is that it is possible to improve the optical efficiency while maintaining see-through performance (external transmittance). In order to improve the optical efficiency by using an array of elements having almost no wavelength selectivity such as a half mirror, the external transmittance has to be partially sacrificed. For example, in order to realize 100% optical efficiency, the end of the waveguide needs to be a mirror having 100% reflectivity. However, the external transmittance at that portion becomes 0%. On the other hand, in the volume hologram waveguide in which region division is performed, since each region has wavelength selectivity, for example, if a hologram having diffraction efficiency of 100% is recorded in each region and the relationship between the region division number K and the wavelength usage rate H_{M} is K=1/H_{M}, the optical efficiency H_{A11} is 100%, but the external transmittance does not become 0% in any region of the waveguide and becomes 1−H_{M}. If it is possible to record the hologram having the diffraction efficiency of 100% by making the wavelength usage rate H_{M} of each region sufficiently small (the region division number K is made sufficiently large), there is almost no decrease in the external transmittance, and there is a possibility that optical efficiency of 100% can be achieved, and it is possible to approach at least the optical efficiency of 100%.

As described above, according to this embodiment, it is possible to provide the waveguide that improves the optical efficiency while maintaining the high see-through performance, the method for manufacturing the waveguide, and the image display device using the same.

### Embodiment 2

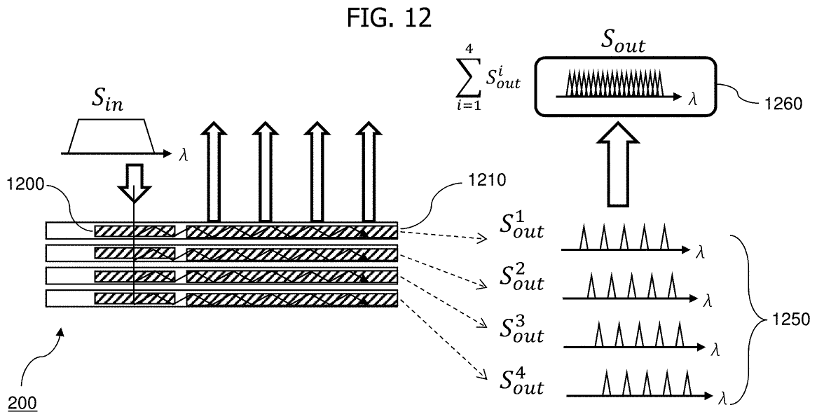

FIG. 12 illustrates a configuration of a waveguide in this embodiment. In this embodiment, the optical efficiency is improved by using a multi-layer structure instead of the region division. In FIG. 12, the waveguide 200 has a four-layer structure, and volume holograms that diffract a set of different wavelengths with respect to a light ray of a certain angle are recorded in each layer. Each layer includes an incidence coupler 1200 and an emission coupler 1210, and in each layer, a pair of input and emission couplers has a configuration in which volume holograms recorded at the same angle are arranged symmetrically. With this, a combination of an angle and a wavelength of a light ray diffracted by the incidence coupler and incident on the waveguide and a combination of the angle and the wavelength of the light ray diffracted by the emission coupler and emitted to the outside of the waveguide match, and the loss of light is minimized. Further, when the light ray angle is deviated in an unintended direction due to the influence of distortion of the waveguide during light guide, the Bragg condition is not satisfied in the emission coupler, so that it is possible to suppress emission of the light ray in an unintended direction. With this, it is possible to suppress image blurring (angle deviation of light rays) due to light guide.

In FIG. 12, the volume holograms recorded in the input and emission couplers of respective layers have different diffracted wavelengths (distributions thereof) and the peak positions of the wavelengths deviate by Δθ₁ₛₜ or more as in the case of Embodiment 1. With this, wavelengths 1250 (S¹out to Stout) diffracted in the respective layers are different, and the wavelength usage rate of the sum 1260 of the wavelengths can be improved.

Incidentally, it is also possible to use the multi-layer structure of this embodiment and the region division recording of Embodiment 1 together, thereby capable of improving the optical efficiency.

Although the embodiments have been described above, the present invention is not limited to the embodiments described above and includes various modification examples. That is, the embodiments described above have been described in detail in order to explain the present invention in an easy-to-understand manner, and are not necessarily limited to those having all the configurations described. Further, a part of a configuration of a certain embodiment can be replaced with a configuration of another embodiment, and the configuration of the other embodiment can be added to a configuration of a certain embodiment. Further, other configurations can be added, deleted, and substituted for a part of the configuration of each embodiment.

### REFERENCE SIGNS LIST

100 Image display device (HMD)
101 Image input unit
102 Image quality correction unit
103 Image projection unit (including light source)
104 Image display unit
200 Waveguide
201, 1000, 1200 Incidence coupler
202 Eye-box enlargement unit
203, 1210 Emission coupler
1010, 1020, 1030, 1040 Emission coupler region

1. A waveguide that has a light diffraction unit that diffracts incident light by a multiplex-recorded hologram, wherein
the light diffraction unit has at least two regions, and the light diffraction unit diffracts of different wavelengths by the respective regions when certain parallel light ray is incident.

2. The waveguide according to claim 1, wherein
the wavelengths diffracted by the respective regions are deviated from each other by a half-value width of wavelength selectivity or more.

3. The waveguide according to claim 2, wherein
the light diffraction unit is used as an emission coupler that converts light propagating inside the waveguide into light emitted to outside of the waveguide.

4. The waveguide according to claim 3, further comprising:
an eye-box enlargement unit that duplicates light rays propagating inside the waveguide and emits the light rays to the emission coupler.

5. The waveguide according to claim 4, wherein
the eye-box enlargement unit is configured to include a mirror surface and a beam splitter surface.

6. The waveguide according to claim 1, wherein
the wavelengths diffracted by the respective regions are composed of a plurality of wavelength groups.

7. The waveguide according to claim 1, wherein
diffraction efficiency of the light diffraction unit has a non-uniform distribution.

8. An image display device, comprising:
the waveguide according to claim 1; and
an image quality correction unit that corrects image quality of an image to be displayed, wherein
the image quality correction unit uniformizes color unevenness, brightness unevenness, and color deviation of an image caused by the light diffraction unit included in the waveguide.

9. A waveguide manufacturing method for manufacturing a waveguide that has a light diffraction unit that diffracts incident light, the waveguide manufacturing method comprising:
forming one hologram by making two plane wave recording beams incident from a direction inclined by a predetermined recording angle θ_{w} symmetrically with respect to a reflection axis of a recording medium;
forming a volume hologram having M different grating intervals by performing multiple recording a predetermined number of times M while changing the recording angle θ_{w}; and
using the volume hologram as the light diffractive unit and sandwiching both sides of the light diffractive unit with substrates.

10. A waveguide that has a light diffraction unit that diffracts incident light by a multiplex-recorded hologram, wherein
the light diffraction unit has a layered structure of at least two layers, and the light diffraction unit light of different wavelengths by the respective layers when certain parallel light ray is incident.
